(19) United States
(12) Patent Application Publication
(10) Pub. No.: US 2005/0005239 A1
(43) Pub. Date: Jan. 6, 2005

(54) System and method for automatic insertion of cross references in a document

(76) Inventor: James L. Richards, Fayetteville, TN (US)

Correspondence Address: James Richards, 58 Boning Rd., Fayetteville, TN, 37334, US

(21) Appl. No.: 10/878,807

(22) Filed: Jun. 28, 2004

Related U.S. Application Data
(60) Provisional application No. 60/485,019, filed on Jul. 3, 2003.

(51) Int. Cl. G06F 17/00

(52) U.S. Cl. 715/530

(57) ABSTRACT

A method for automating the insertion of reference numbers in a document by the steps of providing a digital representation of a document, providing a digital representation of a cross reference table, which includes each term and associated reference number, searching the digital document for a match with each term in the cross reference table and inserting the associated reference number after the matching text in the digital representation of the document. Capability to assist in the location and identification of terms is provided by optionally highlighting the matching text and providing for the display of the document including the highlighted text.

### REFERENCES

This application claims the benefit of the filling date under 35 USC 119(e) of provisional application 60/485,019 to James L. Richards filed on Jul. 7, 2003.

### BACKGROUND OF THE INVENTION

1. Field of the Invention

The present invention relates generally to the field of automatic document analysis and production.

2. Background of the Related Art

Clear and precise language is valuable in all writing, however certain documents require extraordinary care in the handling of particular terms used in the document. Patents, contracts, wills, and technical documents all require precise and consistent terminology.

If several terms are used for the same component, or if one term is used for several components, this can give rise to confusion, and in the case of legal documents this confusion can lead to disputes that are very expensive to resolve. Thus, it is very important in these documents that care be taken to assure maximum consistency in terminology throughout a document.

Of these, patents are perhaps the most demanding. In a patent application, the terms that are used to refer to drawings are of particular interest and are in fact, specified in the rules. Rule 37 CFR 1.74 reads as follows:

37 CFR 1.74 Reference to drawings
When there are drawings, there shall be a brief description of the several views of the drawings and the detailed description of the invention shall refer to the different views by specifying the numbers of the figures and to the different parts by use of reference letters or numerals (preferably the latter).

For a typical application, there may be from three to thirty drawings, each with five to fifteen components. This may result in a number of components from twenty to three hundred or so in the drawings. Each component is referenced in the drawings with a reference number indicated in the drawings. The reference number is used in the discussion of the application to refer to the drawings to clarify which component is being discussed. The reference number helps clarify the discussion and overcome indefiniteness when several terms potentially refer to the same component or when a term is used to refer to several components. It is common practice in patent applications to place reference numbers after nearly every occurrence of a term. Since each reference number may be used in the discussion several times, the potentially three hundred or more components discussed above may result in over a thousand reference numbers in the discussion. Thus, the effort required to insert reference numbers in the text may be substantial. In addition, a typical patent application may be revised several times; drawings may be added and deleted; and reference numbers may be reordered and reassigned several times before the document is finalized. The reference number insertion and revision process is tedious and may be error prone.

As part of the reference number assignment and management effort, terms are typically reviewed to minimize the number of different terms used to reference the same component and to minimize occurrences where the same term is used to reference multiple components, resulting in additional effort required to manage reference numbers.

In addition to patent applications, other legal documents such as contracts, wills, etc use terms in a precise way, often capitalizing all letters of certain terms to signify their special status. Further, for technical documents such as trade journal articles or operation manuals, terms may be referenced to drawings or passages referenced to other technical articles. Terms may also be reviewed for consistent usage as discussed above for a patent application.

Presently, the matching of terms with reference numbers is performed manually. Some practitioners tediously refer back and forth between drawings and text to insert these numbers. Others make a table to assist in the organizing of the process and manually go back and forth among the table, drawings, and text. To make matters worse, as these documents are developed they evolve through several revisions that may involve substantial revision at some late point in development or near the end of development, it is necessary to rearrange the figure order or insert a new figure. Such revisions necessitate a renumbering of reference numbers and correction of the reference numbers in the text. With each manual revision, opportunity for error increases, especially for the final version where time pressure and fatigue may be the greatest.

Thus, there exists a need for a software product that can assist in the production of documents by identifying terms to assist in the review of term usage and by automating the referencing of terms to the drawing figures in a set of documents to improve the speed and accuracy of the referencing process.

### BRIEF SUMMARY OF THE INVENTION

A method of automating the insertion of reference numbers in a document by the steps of providing a digital representation of a document, providing a digital representation of a cross reference table, which includes each term and associated reference number, searching the digital document for a match with each term in the cross reference table and inserting the associated reference number after the matching text in the digital representation of the document. Capability to assist in the location and identification of terms is provided by optionally highlighting the matching text and providing for the display of the document including the highlighted text.

### BRIEF SUMMARY OF THE DRAWINGS

The present invention is described with reference to the accompanying drawings. In the drawings, like reference numbers indicate identical or fumctionally similar elements. Additionally, the left-most digit(s) of a reference number identifies the drawing in which the reference number first appears. Like numbers refer to like elements throughout.

FIG. 1 illustrates a sample of exemplary text written in the style of a patent application, in which reference numbers have been inserted in accordance with the present invention.

FIG. 2 illustrates a cross reference table as used in accordance with the present invention to insert reference numbers in the text of FIG. 1.

FIG. 3 illustrates the exemplary text sample of FIG. 1 with highlighting indicated by a box drawn around the highlighted text.

FIG. 4 is a block diagram illustrating the functional flow of a computer program operating in accordance with the present invention.

FIG. 5 is a block diagram illustrating the relationships among a word processing system, a programming language and code used to implement the cross referencing functions.

FIG. 6 is a block diagram illustrating one method of searching for matching text to insert reference numbers

FIG. 7 is a block diagram illustrating additional detail with respect to a portion of FIG. 4.

FIG. 8 illustrates additional detail with respect to step 614 of FIG. 6.

FIG. 9 is a block diagram illustrating the logic flow for several operations after a valid match is determined.

FIG. 10 illustrates the steps involved in a further embodiment of the invention wherein a reference number is inserted in accordance with spacing and punctuation rules.

FIG. 11 illustrates a user screen showing the presentation of the word processing environment and an option selection window to display cross reference options to be selected by the user.

FIG. 12 is a block diagram illustrating a typical computer that may host the word processor application including the cross reference utility.

### DETAILED DESCRIPTION OF THE PREFERRED EMBODIMENTS

The present invention will now be described more fully in detail with reference to the accompanying drawings, in which exemplary embodiments of the invention are shown. This invention should not, however, be construed as limited to the exemplary embodiments set forth herein.

The present invention is a system, method and software product for assisting in the preparation of a document. More particularly, the invention utilizes computer resources to identify and locate commonly used terms 104 in a document to facilitate review of term 104 usage in order to assure consistent usage throughout the document. In addition, the invention provides a capability for automatic insertion and updating of reference numbers 106 in a document to minimize errors and save time in document development and revision. The invention is particularly applicable for use with patent applications because of the numerous terms 104 and reference numbers 106 typically needed for such documents.

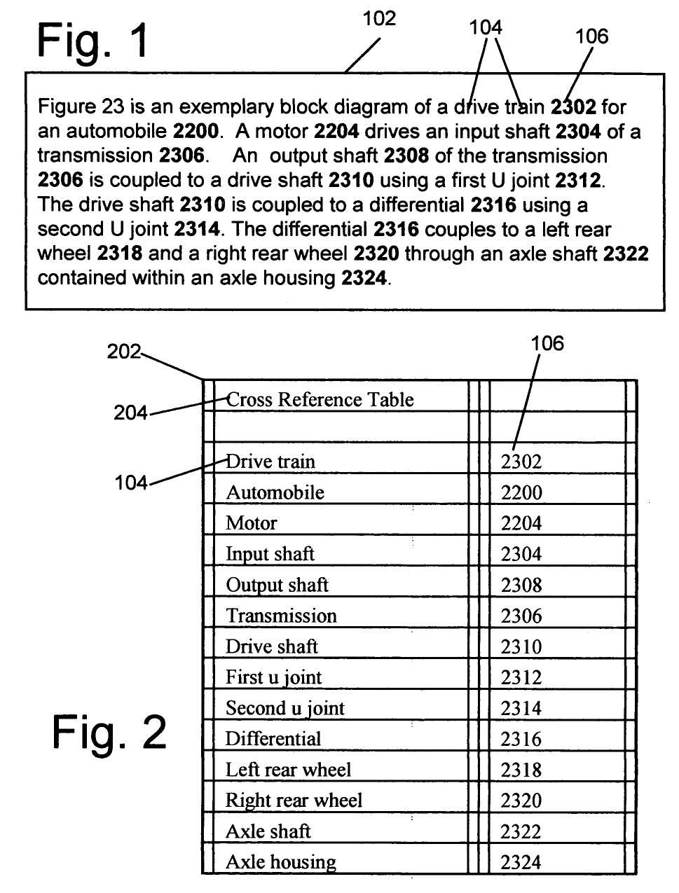

FIG. 1 illustrates exemplary sample text written in the style of a patent application in which reference numbers 106 have been inserted in accordance with the present invention. Referring to FIG. 1, the text sample 102 includes a plurality of terms 104, such as “drive train”, and reference numbers 106, such as “2302”. As shown in the example of FIG. 1, each reference number 106 is inserted after the respective term 104 and set to bold font.

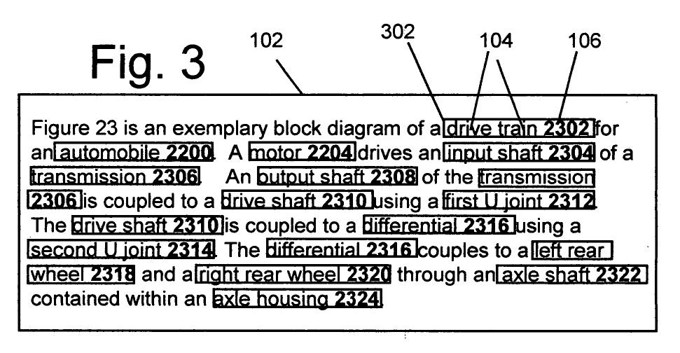

FIG. 2 illustrates a cross reference table 202 as used in accordance with the present invention to insert reference numbers 106 in the text of FIG. 1. In the example of FIG. 2, the cell at column 1, row 1, contains a title for the table: “Cross Reference Table”. The title is used as identification text 204. The remaining rows of column 1 comprise a list of terms 104 to be matched in the text sample 102. Note that terms 104 may comprise one or more words and may contain punctuation (not shown in this example). Case is typically not matched when searching for terms 104 in the document text. Column 2 comprises a list of reference numbers 106 associated with the respective terms 104 from column 1. Reference numbers 106 may comprise entirely numeric characters, may contain alpha characters, or may comprise entirely alpha characters. In one embodiment, the reference numbers 106 are not restricted as to potential characters and may contain special characters, icons and graphics. In this specification the words “reference”, “reference number” and “cross reference” are equivalent. Except when the context clearly indicates otherwise, the words “reference” and “reference number” as used in this specification are intended to include the possibility of some or all numeric characters, alpha characters, special characters, icons, and graphics.

In one embodiment of the invention, the matching text found by comparing document text with terms 104 from the cross reference table 202 is indicated by highlighting the matching text in the document as shown in FIG. 3. FIG. 3 illustrates the exemplary text sample 102 of FIG. 1 with highlighting indicated by a box drawn around the highlighted text. A box is used to indicate the highlight 302 area because patent publication does not permit highlighting. The highlighting as seen on a typical computer screen or as printed on a color printer would typically fill the area shown by the box with a background color, but would not usually show the box outline itself A light color, such as yellow, is usually selected for the highlight 302 color so as not to interfere with the readability of the text.

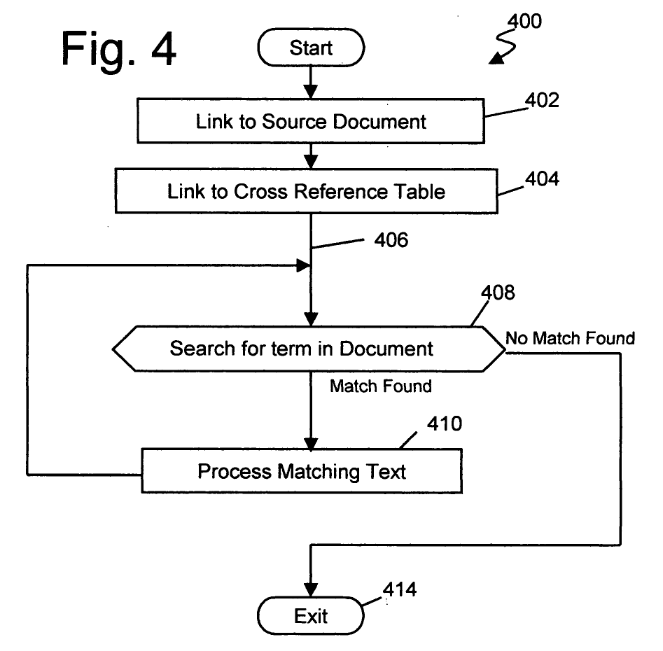

The detailed operation of the invention will now be described with reference to FIG. 4. FIG. 4 is a block diagram illustrating the ftmctional flow of a computer program operating in accordance with the present invention 400. The user starts by providing a source document, or portion of a source document under development, in electronic form. The document may typically be in a word processing program format, but may be in a text file format or memory format. The user also provides a cross reference table 202 in electronic format. The cross reference table 202 will have a column, or portion, for terms 104 and a column, or portion, for associated reference numbers 106. Upon initiation, the cross reference utility 504 links with the source document, step 402, and cross reference table 202, step 404, and then proceeds to examine the document for text which matches a term 104, step 408. Upon finding a match, the match is processed, step 410. The processing may include highlighting the matching text, changing the text color, inserting the associated reference number 106, counting the number of matches, noting the position of the match, or other processing. When the processing for a match is completed control returns to step 408 where the document is searched for a new match. When no more matches can be found the program exits, 414.

Software Environment

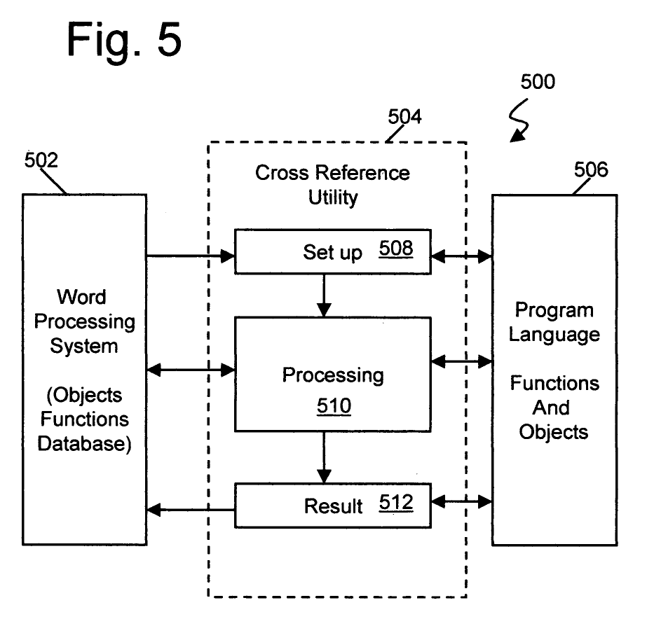

A preferred embodiment of the invention utilizes the object model of a word processing system 502 to implement special fimctions that can be initiated using menu buttons in the word processing user environment. These relationships are illustrated in FIG. 5. FIG. 5 is a block diagram illustrating the relationships among the word processing system 502, the programming language, and the code used to implement the cross referencing functions. Referring to FIG. 5, the word processing system 502 comprises the word processor program, the document text and associated data, along with styles or templates necessary to form the document. The word processing program includes objects, functions, and properties that are exposed in an interface and available for use in the cross reference utility 504. The cross reference utility 504 comprises the code used to effect the desired functionality. The code includes a setup portion 508, a processing portion 510, and a results portion 512. The programming language comprises the compiler/interpreter, editor, and debug environment and help documentation. The programming language, in a sense, supplies the glue necessary to assemble the functional elements of the word processing system 502, the cross reference utility 504, and the built in functions of the programming language, into a functioning unit.

The word processing system 502, in one embodiment, may be Microsoft® Word, however other systems such as Word Perfect® may also be used. Microsoft® Word has a further advantage in that the Macro capability includes a Visual Basic programming environment and most if not all of the features in Microsoft® Word that are available through the keyboard are also available through the object language extensions to the Visual Basic programming environment. Thus, complex ftmctions may be added to the word processing environment where the functions may be initiated conveniently by buttons on the Microsoft® Word menu bars.

Referring to FIG. 5, in operation, a user selects a cross reference function from within the word processing system 502. The setup portion 508 examines any elected options and may display a query screen to verify options or ask for input. Once options are established and appropriate states set, the processing portion 510 examines the document to retrieve terms 104 from the cross reference table 202, search for matching text and insert reference numbers 106. The processing portion 510 utilizes Word objects and functions to retrieve information from the Word document database or store information in the document database. Once processing is complete, the results portion 512 may then store the results back in the document database.

Micosoft Word provides three selections for storing Macros and related programs. Word macros may be stored in three different locations. Each location has its own advantages. Macros may be stored in the document, in a template, or in the NORMAL.DOT template. The NORMAL.DOT template is loaded for editing all documents. Additional templates may be optionally attached by the user. A document may be created based on a template by opening the desired template in the File—New selection window in Word. Any of the potential program storage locations may be used for storing the cross reference program. In one embodiment, the cross reference macro, control buttons and icons, and shortcut, or accelerator key information are stored in a template file. This storage location has an advantage for distribution of the cross reference program as a product because the end user can attach the template file without disturbing the user's NORMAL.DOT template file that may contain customizations for that user.

Documentation Books, Online Help

The details of the word object model and visual basic language can be found in numerous documents available in bookstores as well as in the Microsoft® Word online help. To get to the full online help, record a macro and then select tools—macro—macros—and then select the macro just recorded and select edit. (This process applies to Word 2000) These steps will bring up the visual basic environment and editor. The “?” button will then give access to both Microsoft® Word and Microsoft® Visual Basic help. The Help Function is in HTML hyperlinked format.

Other more traditional texts include: Word 2000 Developer's Handbook, Guy Hart-Davis, Sybex, Inc. ISBN0-7821-2329-5, and VB and VBA in a Nutshell, Paul Lomax, O'Reilley & Associates, Inc, ISBN 1-56592-358-8

Software Functions Available

To illustrate generally the type of fimctions available in the Word and VB object models that may be used to advantage in producing software in accordance with the present invention, some examples are provided as follows:

Find object and execute method

The find object and execute method are used to find a matching text string in the document. An initial range is specified either by a range or selection object. The initial range is the portion of the document to be searched. Upon completion, the range includes the matching text, if found. A wealth of options may be set to control the behavior such as matching case, matching whole words, matching formatting, etc.

Selection object

The selection object represents the selected text. On the screen, this is the text shown in reverse video when the mouse is dragged across a section of text. When only the cursor point is selected, the beginning and ending points of the selection are equal.

Range Object

A range object specifies the beginning and ending character locations of a range. A range object may be used to specify the range for an operation on the text. Several ranges may be defined and a range need not be the selection.

Tables Collection Object

The tables collection object includes all of the tables in a document. The tables collection may be searched for a table with some identifying characteristic as is done in the present invention to search for the cross reference table 202 by checking for “Cross” in the cell in Row 1 column 1.

Userform1.show (vbmodeless)

The userform and associated controls are a valuable set of tools for presenting user options and getting user input. The show method presents the userform to the user. Specifying vbModeless allows the program to proceed while the form is displayed, otherwise the program thread stops to wait for user input. The modeless option may be used with a progress bar to show incremental progress.

Application.screenupdateing=false

Setting the Application.screenupdating property to “false” allows the program to execute without having to update the screen for each step. This stabilizes the screen and improves execution time.

Field Update

In one embodiment, fields may be used for the reference numbers 106. The range.fields.update method may be used to update the fields, where range is a range object.

Range TextRetrievalMode IncludeHiddenText

The IncludeHiddenText property is set to “true” to include hidden text in the find and execute operation. Hidden text may be used to control the matching of terms 104. Added hidden letters may prevent a match or enable a match as described later in this disclosure.

DoEvents

The DoEvents command in VB may be used to enable other windows to run while waiting for user input.

It can be appreciated that many additional functions are available through the object model and the prospective programmer is advised to consult the available texts on the subject for more complete documentation of these functions.

Detailed Properties of the Invention

A further aspect of the invention is the observance of punctuation and spacing rules when adding reference numbers 106. A term 104 may be found mid sentence, end of sentence, or next to a comma, colon, or parenthesis. Each potential location needs to be handled properly to avoid the necessity of manual cleanup editing of the document.

Also, plural and possessive endings should be recognized and handled properly so as not to split up a word or miss a term 104 instance of use. For example, when adding a reference number 106 “23” to the term 104 “wheel,” the reference number 106 should also be added to the term 104 “wheels” and result in “wheels 23” instead of “wheel 23s.” Or, when adding the reference number 106 “24” to “battery”, “batteries” should also be searched for a match and the result should be “batteries 24”.

A further issue is the potential for incorrect matching of terms 104 within words. For example, the term 104 “ring” should not match with “bearing”. Terms 104 found within words, either at the beginning or the end, should not be recognized as matching terms 104.

Location Of First Match

In a further advantage of the invention, the first occurrence of a term 104 may be designated in the text and its position noted in a table of terms 104. The table of terms 104 may be subsequently sorted in order of first occurrence as an aid in assigning reference numbers 106 in order of first occurrence. Optionally, the cross reference utility 504 may automatically assign reference numbers 106 in order of first occurrence and place the resulting reference numbers 106 in the text.

### EXAMPLES

Table 1 illustrates the insertion of reference numbers 106 into text in a number of different situations involving punctuation, plural endings and partial matches. In Table 1, column 1 is table line number for use in the present discussion. Column 2 is the term 104 to be placed in the cross reference table 202. The term 104 is to be matched with text in the document. Column 3 is the reference number 106 to be placed after a match is found in the document. Column 4 is exemplary document text to be operated on using the column 2 term 104 and column 3 reference. Column 4 is the result of the operation.

In the example of line 1, the term 104 battery is found in the text and the reference number 106 is inserted after the match. Note that case is not matched and a match is found even though the term 104 is capitalized and the text is not.

In the example of line 2, the reference number 106 is inserted between the match and the comma.

In the example of line 3, the reference number 106 is inserted between the match and the period.

In the example of line 4, the reference number 106 is inserted between the match and the right parenthesis.

In the example of line 5, the reference number 106 is inserted between the match and the semicolon.

In the example of line 6 the existing reference number 106 is deleted and replaced by the new reference number 106. The example of line 6 further. Note that the two reference numbers 106 have a different length to illustrate that the length of the two reference numbers 106 need not be the same.

The example of line 7 illustrates deleting a reference number 106 and adding a reference number 106 in combination with a comma.

The example of line 8 illustrates that the length of the deleted reference number 106 may be longer than the length of the replacement reference number 106.

The example of line 9 illustrates the correction of a space omission while replacing a reference number 106.

The example of line 10 illustrates the insertion of a reference number 106 before a left parenthesis in combination with the correction of a space omission.

The example of line 11 illustrates the replacement of a reference number 106 in combination with the correction of a space omission. Note that this result is achieved when the reference numbers 106 are numeric characters only. If the reference numbers 106 are defined as a word containing a numeric character, as in one possible user option, the entire text “22terminal” may be considered a reference number 106 and deleted. Alternatively, when fields are used to define reference numbers 106 this situation may be correctly resolved for any character combination.

The example of line 12 illustrates the insertion of a reference number 106 where the match includes a possessive ending.

The example of line 13 illustrates the insertion of a reference number 106 where the match includes the plural ending “ies”.

The example of line 14 illustrates the insertion of a reference number 106 where the match includes the plural ending “s”.

The example of line 15 illustrates the insertion of a reference number 106 where the match includes the plural ending “es”.

The example of line 16 illustrates the correct non-match of the sub word “ring” at the end of the word “Bearing”. The absence of a valid match being indicated by the absence of an inserted reference number 106 in the result column.

The example of line 17 illustrates the correct non-match of the sub word “arm” at the beginning of the word “Army”.

TABLE 1
Examples of Reference Number Insertion Situations

| Line | Term | Reference | Text | Result |
|---|---|---|---|---|
| 1 | Battery | 235 | Red battery | Red battery |
| | | | terminal | 235 terminal |
| 2 | Battery | 235 | Red battery, | Red battery 235, |
| | | | terminal | terminal |
| 3 | Battery | 235 | Red battery. | Red battery 235. |
| | | | Terminal | Terminal |
| 4 | Battery | 235 | Red (battery) | Red (battery 235) |
| | | | terminal | terminal |
| 5 | Battery | 235 | Red battery; | Red battery 235; |
| | | | terminal | terminal |
| 6 | Battery | 235 | Red battery 33 | Red battery 235 |
| | | | terminal | terminal |
| 7 | Battery | 235 | Red battery 33, | Red battery 235, |
| | | | terminal | terminal |
| 8 | Battery | 235 | Red battery | Red battery 235 |
| | | | 3456 terminal | terminal |
| 9 | Battery | 235 | Red battery22 | Red battery 235 |
| | | | terminal | terminal |
| 10 | Battery | 235 | Red battery | Red battery 235 |
| | | | (terminal) | (terminal) |
| 11 | Battery | 235 | Red battery | Red battery 235 |
| | | | 22terminal | terminal |
| 12 | Battery | 235 | Red battery's | Red battery's |
| | | | terminal | 235 terminal |
| 13 | Battery | 235 | Ten | Ten |
| | | | batteries | batteries 235 |
| 14 | wagon | 235 | Ten wagons | Ten wagons 235 |
| 15 | box | 235 | Ten boxes | Ten boxes 235 |
| 16 | ring | 235 | Bearing | Bearing |
| 17 | arm | 235 | Army | Army |

Detail Operation Of The Invention

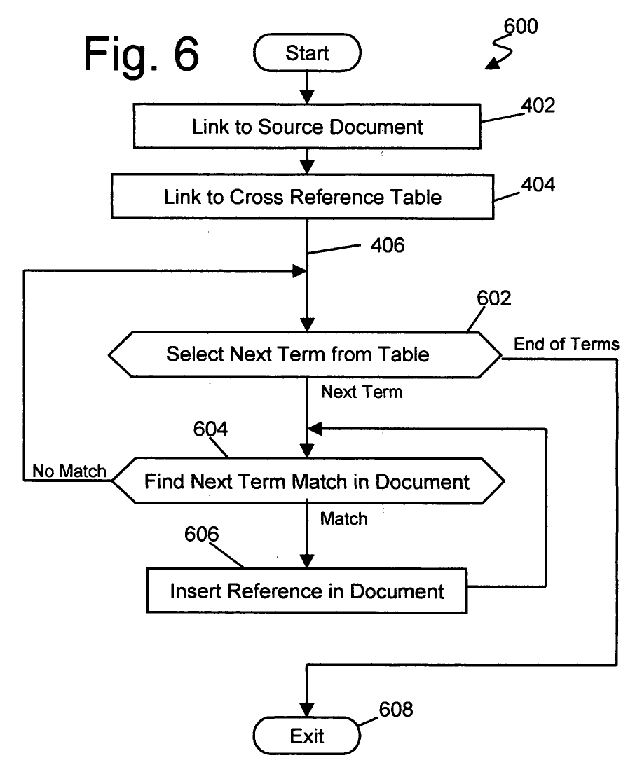

Further detailed embodiments of the invention will now be described beginning with FIG. 6. FIG. 6 is a block diagram illustrating one method of searching for matching text to insert reference numbers 106

Several approaches may be employed in the searching for matches. For example, the text may be searched for each term 104 in turn in the table, exhausting the matches for each term 104 before proceeding to the next term 104. Alternatively, the text may be examined one word at a time for all terms 104 in the table (including surrounding words where the term 104 comprises more than one word) until the text is exhausted. FIG. 6 illustrates the first method where the text is searched for each term 104 in turn in the table.

Referring to FIG. 6, in step 402 and step 404, the cross reference utility 504 links to the source document and cross reference table 202. Microsoft® Word provides a “Tables” collection object comprising the tables in a document. This collection object may be utilized to search for a table identified as the cross reference table 202 in a document that may contain numerous tables. In the example of FIG. 2, Row 1, Column 1 contains a title for the table: “Cross Reference Table ”. The title text being in Row1, Column 1 may be used by the cross reference utility 504 program to identify the cross reference table 202 in the document. Other identification methods may also be used to find the cross reference table 202.

Referring to FIG. 6 and FIG. 2, the next step in FIG. 6 begins the process of searching for matching terms 104 and inserting reference numbers 106. In step 602, the next term 104 from the table is selected. The first time this step is executed, the term 104 from FIG. 2, row 2, column 1 is selected. In the example of FIG. 2, the term 104 is blank, or empty. Blank terms 104 are not processed and may be used for formatting appearance of the table. Thus the next row would be selected: row 3, column 1. This cell in FIG. 2 contains the term 104 “Drive train”.

In step 602, the next term 104 is selected from the table. In step 604, the document is searched for matching text In this example, the document is searched for text matching “Drive train”. If a match is found, in step 606 the reference number 106 from column 2, row 3 is inserted after the instance of matching text. Step 604 may also check for an existing reference number 106 and may observe punctuation and spacing rules. After the reference number 106 is inserted, the document is fuirther searched for additional matches until no matches can be found in the remaining document. When no match is found (no match in the remaining document also means that all matches have been found, if any, in the previously searched portion of the document), control returns through step 608 to select the next term 104 from the next row in FIG. 2, in the example of FIG. 2, this is column 1, row 4, “Automobile”. The process continues until all terms 104 in the cross reference table 202 have been matched in the document, whereupon control is returned to the word processor which now contains text with reference numbers 106 added after each occurrence of each term 104 in the cross reference table 202.

Further Features And Embodiments

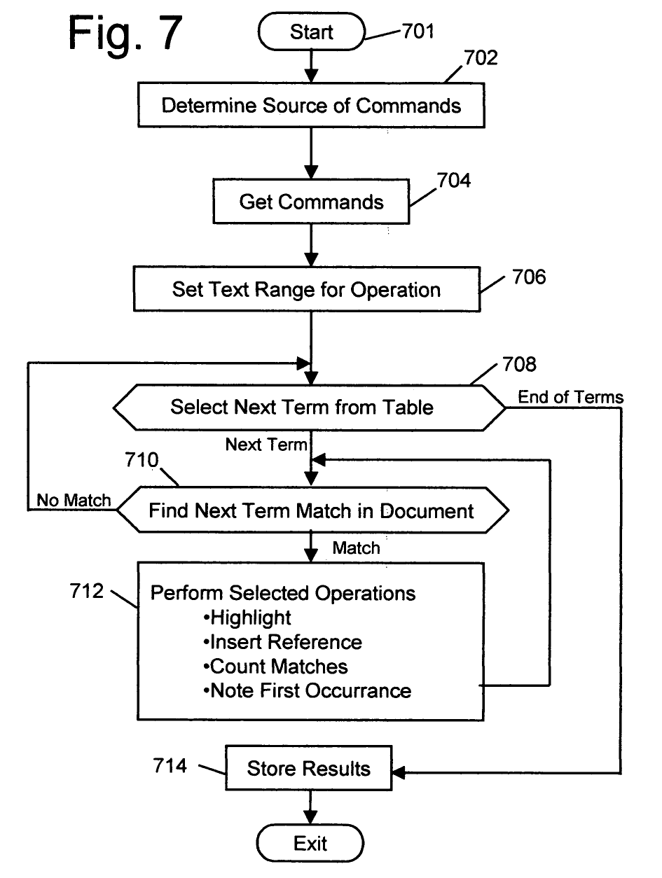

A further embodiment of the invention will now be described with reference to FIG. 7. FIG. 7 is a block diagram illustrating additional detail with respect to a portion of FIG. 4. FIG. 7 begins with step 701 at Point 406 in FIG. 4. In FIG. 7, step 702, various potential locations are searched for option commands. If option commands are supplied in the cross reference table 202, the commands from the cross reference table 202 will be used and a user screen will not be displayed, but the program will proceed to execute without delay. If no option commands are supplied in the cross reference table 202, the document properties are searched for option commands. If none are found, a user screen is displayed presenting the options available with the default values checked. The user may then change the options as desired. The user selectable options may comprise any one or several of the following:
Search the current selection
Search the current paragraph
Search the current section
Search the disclosure portion of the document
Insert reference numbers 106
Option to delete reference numbers 106 instead of inserting them
Highlight 302 matching text
Highlighting color selection for first occurrence of a match
Different highlighting color selection for subsequent occurrences of a match
Special text color for matching text
Bold or italic for matching text
Bold or italic for reference
Count the number of matches for each term 104
Record the location of the first match for each term 104

In step 704, the commands are processed to set parameters for processing the text.

In step 706, the text range for the operation is established. If the user has made a selection comprising more than the cursor point, the user's selection is set as the range for operation. If not, then the range specified by an option command is used, if not, the default range is chosen, the default being preferably the current paragraph containing the cursor. In one embodiment directed to a patent document, a disclosure range may be selected. The start of the disclosure range is determined by searching the text for the first occurrence of the string: “Detailed Description”. The end of the disclosure range is determined by searching the text for the string: “claim:” or “What is claimed is:”. Alternatively, a range may be defined by other indicators such as by two user selected strings, or by a bookmark range determined by the user.

Step 708 begins the loop that selects terms 104 from the cross reference table 202 as each next term 104 is selected from the cross reference table 202. The first term 104 selected is from row 2 because the title is in row 1. Step 710 begins the loop that searches for matching text in the document. Each subsequent match sets the matching range to the remaining text in the operation range after the last match found. When no match is found, control is returned to step 708 to select the next term 104. When no unprocessed terms 104 remain in the cross reference table 202, control passes to step 714

When matching text is found in step 710, the matching text is processed in step 712 according to the user options selected. If selected, the matching text is highlighted, the text color is changed, and/or bold may be applied, and/or the reference may be inserted or deleted, etc. If this is the first occurrence of a match for the selected term 104, the location in character units from the beginning of the document is noted. The count of the number of matches for the selected term 104 is incremented.

In step 714, data collected during the processing may be stored in the document. If the user has selected the command to display count data, a count of the number of matches for each term 104 is stored in the respective row for the term 104 in column 3 of the cross reference table 202. If the table does not already have a column 3, one may be created. If the user has selected the command to display the first occurrence location, the character number of the first occurrence of a match is stored for each term 104 in the respective row for the term 104 in column 4 of the cross reference table 202. If no column 4 exists in the cross reference table 202, the column 4 may be created.

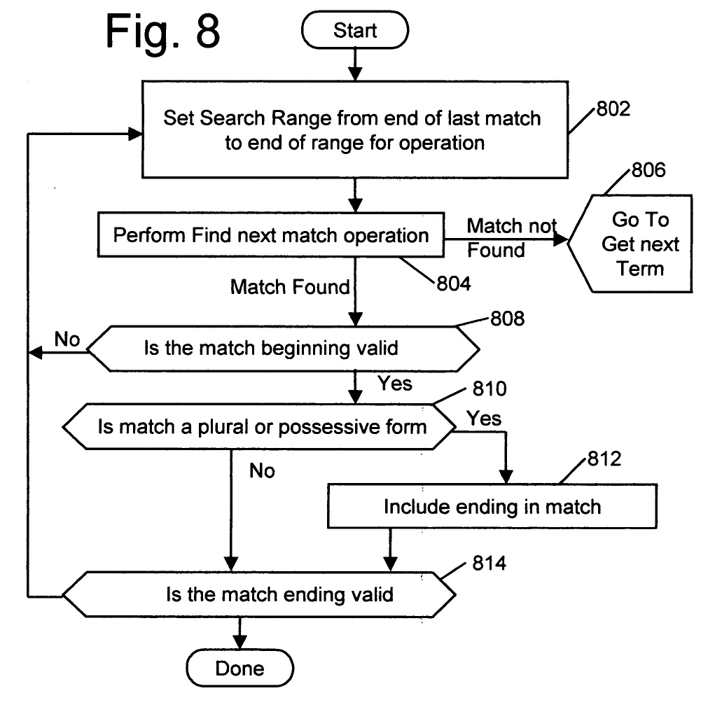

FIG. 8 illustrates additional detail with respect to step 710 of FIG. 7. FIG. 8 illustrates the steps involved in searching for a match and determining the validity of the match, if a match is found. Referring to FIG. 8, in step 802, the search range is defined for use with the Microsoft® Word FIND object and EXECUTE method. Thus, the range is set to the text to be searched, which is from the end of the last match found to the end of the search range. On the first pass, the entire search range is searched. The search range is the range selected by the user, such as paragraph, section, selection, or disclosure as previously described. In step 804, the Microsoft® Word EXECUTE method is used to perform the search. If a match is not found, control is returned in step 806 to select the next term 104 from the cross reference table 202.

If a match is found, the match is checked for validity. Checking for validity is not essential, but improves performance by reducing the amount of cleanup manual editing that would be necessary to correct the document. The first check, step 808, examines the character just before the matching text. If this character is an alpha character (not a space), then it is assumed that the match is part of a longer word and the match is declared invalid and control returns to step 802 to search further for another match. An example of an invalid match would be where the term 104 is “ring” and the initial match is found in the word “bearing”. Note that a space, or paragraph marker or “empty” value for the preceding character will result in a valid match under the test of step 808. Then next test is to check for possessive or plural endings in step 810. In step 810, if the characters after the match are “s”, “'s”, “es”, the characters will be included in the match in step 812.

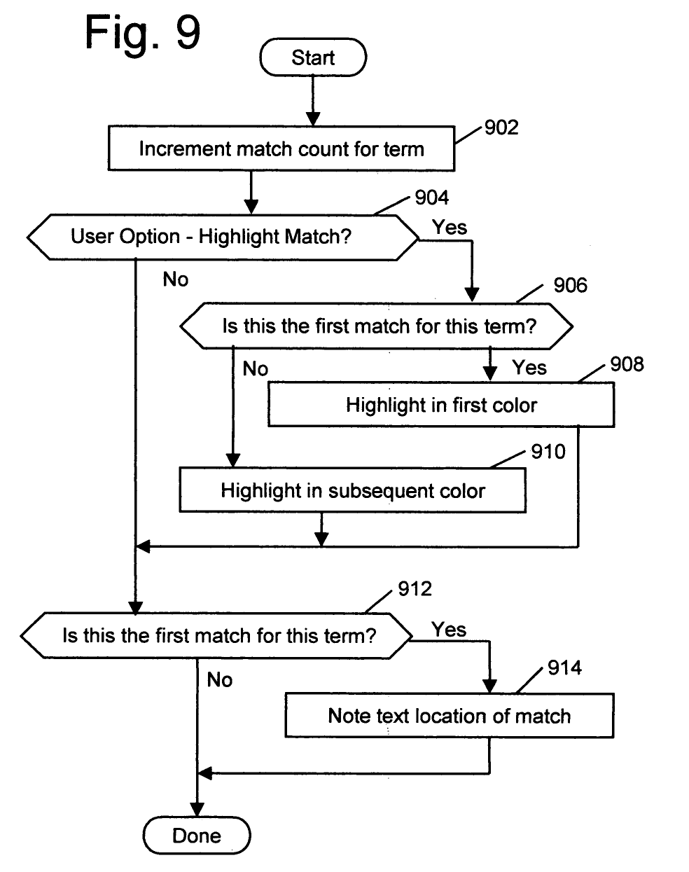

In step 814, the character following the updated matching text is examined. If the following character is an alpha character, the matching text is assumed to be part of a larger word, the match is declared invalid, and control is returned to step 802 to continue to search for another match. If the match is found valid, control is passed to the next function as shown in FIG. 9.

FIG. 9 is a block diagram illustrating the logic flow for several operations after a valid match is determined. Referring to FIG. 9, in step 902 a counter associated with the term 104 is incremented to indicate the total number of instances of matching text that have been found for each term 104. In step 904, the user selectable option to highlight 302 matching text is examined. If the user selected highlighting, control passes to step 906 where highlighting color is selected according to whether the match is the first match for the associated term 104. In step 908, one color is selected if the match is the first occurrence for the term 104. In step 910, another color is selected for the subsequent matches for the term 104.

In step 912, and step 914, if this is the first match for a given term 104, the location of the match is recorded in memory. In Word, the location may be obtained from the START property of the RANGE object that points to the matching text. The units of the location are in characters from the beginning of the document. The location information may be used to sort and arrange terms 104 and reference numbers 106 as will be described later herein.

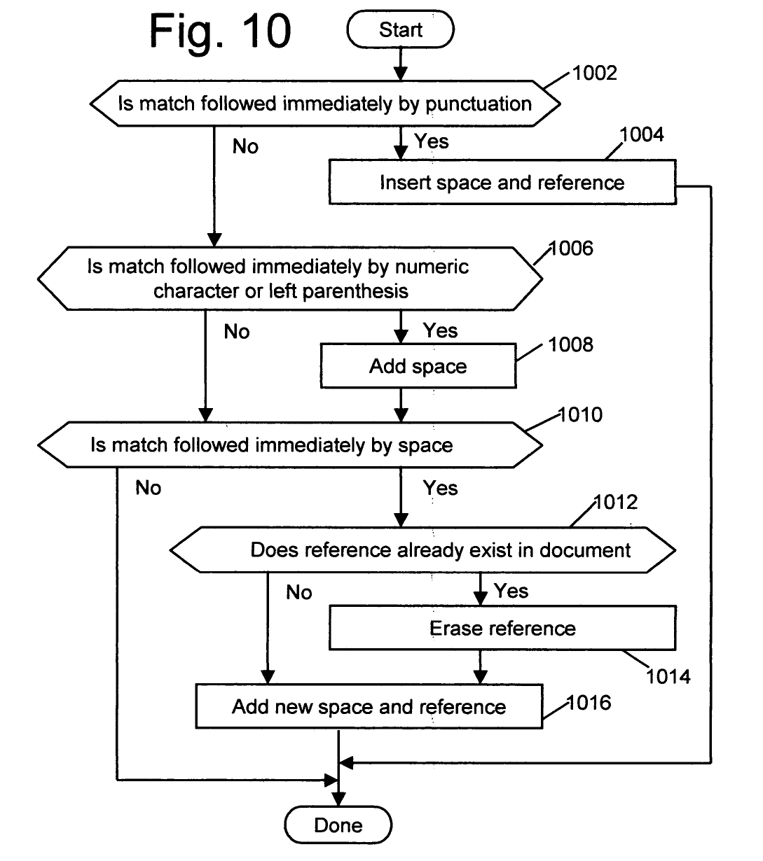

FIG. 10 illustrates the steps involved in a further embodiment of the invention wherein a reference number 106 is inserted in accordance with spacing and punctuation rules. Referring to FIG. 10, in step 1002, if the character after the matching text is a comma, period, colon, semicolon, or right parenthesis, a space and the reference number 106 are inserted before the punctuation, step 1004. If not, control passes to step 1006.

In step 1006, if the match is followed immediately by a numeric character, in accordance with one option, it is assumed that the user omitted a space and that the numeric character is part of a reference number 106, in which case, a space is added in i4step 1008. A space may also be added if the match is followed by a left parenthesis.

In step 1010, if the match is not followed immediately by a space, control is returned to search for a new match. If the match is followed immediately by a space, control is passed to step 1014 where the subsequent text is tested for the existence of a reference number. Several optional algorithms are used to distinguish a reference. In one option, if the word following the matching text contains all numeric characters, the word is declared a reference number. In another option, if the following word contains a numeric character, the word is declared a reference number. A reference number may also be identified by containing a special character or by being in a Microsoft® Word Field, or Bookmark or by being highlighted or by being shown in a special text color or other attribute that could be applied and would not likely be needed by the user for another purpose.

If a reference is found in step 1014, it is assumed that the reference may not be accurate and the reference is erased, or deleted in step. In one embodiment, the associated leading space is also deleted.

In step 1016, a new space and reference are inserted. Adding both space and reference to the end of the matching text will propagate any text characteristics assigned to the matching text such as highlighting, bolding, etc. In accordance with a user selected option, the reference may have its own characteristics such as bold text. When step 1016 is complete, control returns to FIG. 7, step 701 to search for the next match.

When all terms 104 are searched and processed, control is passed to FIG. 7, step 714, where results are stored in the document in accordance with user selected options.

Alternative Embodiments, Fields

In an alternative embodiment, the reference numbers 106 may be placed in Word Fields. In particular, the DOCVARLABLE field is well suited for implementation of reference numbers 106. Word fields are special text fields tied to particular functions. For example the page number is a field, a date may be entered as a field using the edit—insert—field command. Fields are typically updated upon saving the file or upon printing. Fields may also be updated using the range.update method. The DOCVARIABLE field sets up a collection of document variables, each with a name and a value. These variables may be used to accomplish cross referencing by creating a DOCVARIABLE field for each term 104 and assigning a unique identifier for each DOCVARIABLE field name. The identifier, in one embodiment, may be the term 104 itself. In another embodiment, the identifier may be a sequence number, or a random number or random set of characters. The associated value would be set to the reference. To insert reference numbers 106, the cross reference utility 504 would insert a DOCVARIABLE field in the document text according to the variable name. To update the reference numbers 106, each DOCVARIABLE value would be set to its respective new value in accordance with a cross reference table 202 and then the range.update method would be run for the desired range to display the new values in the text. Using fields has an advantage in that no special characters need be used or are forbidden to be used in the reference because the identification of a reference is by the use of the field.

Use of the Invention

A use example will now be described to further the understanding of the benefits and features of the invention. The use example will utilize a cross reference utility 504 program embodying the invention.

In a typical scenario, a user may begin by generating a draft portion of a patent disclosure together with a few draft figures associated with the disclosure. The user may optionally include reference numbers 106 manually inserted in the draft text. The draft disclosure is generated using a word processing program with the invention installed as an attached function.

To use the invention, the user first prepares a cross reference table 202 of entries comprising the term 104 and the reference number 106 for each entry. The user then creates a word processor table with “Cross” in the cell at row 1, column 1. Term 104 and reference number 106 entries are then entered in succeeding rows with the term 104 in column 1 and the reference number 106 in column 2 as shown in FIG. 2.

When the cross reference table 202 is complete, the user selects a command button from the menu bar to initiate the cross reference utility 504. The command button brings up a window showing option selections. The user would typically set the range to the current paragraph, highlight 302 matching text, and insert reference numbers 106. The user then selects the Run button 1112 and the cross reference utility 504 begins execution, displaying a progress bar showing the state of progress. When complete, the updated screen is displayed with the matching text highlighted and reference numbers 106 inserted. If any reference numbers 106 were inserted manually, they will be updated in accordance with the cross reference table 202.

After running the cross reference utility 504, the user would inspect the operation for errors. If any text terms 104 were misspelled or have too many spaces, these terms 104 will not match and can easily be spotted because of the lack of highlighting. Some unhighlighted terms 104 may be traced to duplicate use of terms 104 for the same component. The table may be updated to include the duplicate term 104, or the text may be modified to use the existing term 104.

Text may be developed in this way, a paragraph or section at a time until the whole text is complete. When the cross reference utility 504 operation is verified for each paragraph, subsequent table updates will yield correct results in the document.

When a revision is made that affects reference numbers 106 throughout the disclosure, it is desirable to update the entire disclosure. The user first updates the cross reference table 202 and checks it for accuracy. Then the user runs the cross reference utility 504, selecting the “Disclosure” operation range. Once complete, the text is then reviewed for accuracy.

When a first rough draft is complete, the user may decide to examine reference order. To do this, the cross reference utility 504 is run on the disclosure as described above, and when the option screen appears, the option for display of count and first occurrence is selected. “RUN” is selected and when complete, the count and first occurrence locations are in the cross reference table 202.

The user will typically make a copy of the resulting table for sorting and analysis. The copy may be made in the word processor or in a spreadsheet program or other analysis program. Once a copy is made the user may sort the rows. The text may then be examined to see why the first occurrences are in the order as given. Adjustments may then be made in the text to yield the desired order. Once the desired order is achieved, the reference numbers 106 may be renumbered in order of first occurrence and then the cross reference utility 504 may be rerun to update the new reference numbers 106 in the text.

In one embodiment of the invention, an option is provided to sort and reassign reference numbers 106 automatically. A column may be maintained in the cross reference table 202 for original reference numbers 106 or some other stable reference to help maintain correspondence with the drawings which may be in a different software package or may be in paper format.

In another embodiment of the invention, the drawings may be updated automatically to correspond with the text by using the automation interface of Microsoft® Office. To use this feature, the drawings must be done in a compatible drawing tool such as Microsoft® Power Point. When the user selects this option, the cross reference macro opens the Power Point document from within Word and searches for reference numbers 106 identified by a pattern such as key character or number pattern. The utility then replaces existing reference numbers 106 with the updated table values.

Occasionally, it is desirable to use the same term 104 for two or more reference numbers 106, relying on the reference to separate the different uses for the term 104. For example, the terms 104 “step 34”, and “step 25” differ only in the reference number 106. The word “step” may be reused a number of times and no suitable qualifying word can be found to distinguish the different versions of “step”.

One method of distinguishing different uses of the same term 104 is to use the hidden text feature of the word processor. A text string may be added to each use of the common term 104 to distinguish the different uses. A corresponding entry may be made in the cross reference table 202. For example, “step 34” may become “abstep 34” with the “ab” being set to hidden text so that it does not confuse the reader. In a like manner “step 25” may become “acstep 25” with the “ac” being set to hidden text. The cross reference table 202 would have the terms 104 “absetp” and “acstep” as entries and reference numbers 106 may then be assigned and updated without ambiguity or confusion. In Microsoft® Word, the (range).TextRetrievalMode.IncludeHiddenText property needs to be set to true to allow the FIND and EXECUTE methods to see the hidden text when making matches between the text and cross reference table 202.

In an alternative embodiment where fields are used to display reference numbers 106, a field name provides a mechanism for distinguishing reference numbers 106. One method of assigning field names is to utilize a special character, such as the tilde “˜”, which is not used for any other purpose in the document. The special character is used to signify to the cross reference utility 504 that the string is to be converted to a field name. For example “step 34” could be written “step ab˜34”. To process this string, the cross reference utility 504 searches for occurrences of“˜”. When a “˜” is found, characters immediately before the “˜” are interpreted as a field name, in this case “ab”. The characters after the “˜” are interpreted as the reference. The “ab˜” could then be set to hidden text or erased so that the resulting text reads “step 34”

The use of fields with associated field names can decouple the reference from the term 104 or any need for an associated term 104. The lack of association with a term 104 allows the handling of special circumstances.

In another embodiment, the text color may be used to hide text or make it invisible to generate unique versions of a common term 104. For example “step 34” could be written as “abstep 34” where the text “ab” is set to white text, which is the same as the background and is thus not seen or invisible. In addition, it is desirable to make the “ab” a small font and to use few letters or numbers to minimize the blank space occupied by the invisible text. A special very small or zero length font may be created and used for the invisible text purpose.

There is often a need to list a range of reference numbers 106, for example, “steps 14 through 23”, or “steps 14, 15, and 16”. In these examples, “steps 14” will match and update correctly through the table, however the “23” and “15” and “16” have no associated reference. One method of handling a range of reference numbers 106 is to explicitly expand the text to use a term 104 with each reference. For example, “steps 14 through 23” becomes “steps 14 through step 23”, and “steps 14, 15, and 16” becomes “step 14, step 15, and step 16”. Also, one may also use hidden text or other methods to distinguish the different “step” terms 104. Thus, “step 14, step 15 and step 16” may actually be “astep 14, bstep 15 and cstep 16” with “a”, “b”, and “c” being hidden.

If the explicit expansion process produces awkward text, hidden text may be used to hide the subsequent term 104 listings thus, “astep 14, bstep 15, and cstep 16” would read “step 14, 15, and 16”, with “a”, and “bstep ” and “cstep ” being hidden.

Figure Numbers

Figure numbers may also be assigned by table reference. To assign figure numbers, the user could enter “xFig.” as a term 104, in the cross reference table 202 and “1” as the associated reference. In the text, the “x” would be set to hidden text. The result after running the cross reference utility 504 would be “Fig. 1”. The “xFig.” designation could be stable for all revisions of the document text, changing only the cross reference table 202 as figures are added or reordered.

When hidden text is used, the hidden property may propagate to the reference number 106, resulting in a hidden reference number 106, especially when the last character of a term 104 is hidden. In one embodiment of the invention, hidden reference numbers 106 are prevented from occurring by setting the hidden property of the reference number 106 to false.

User Option Window

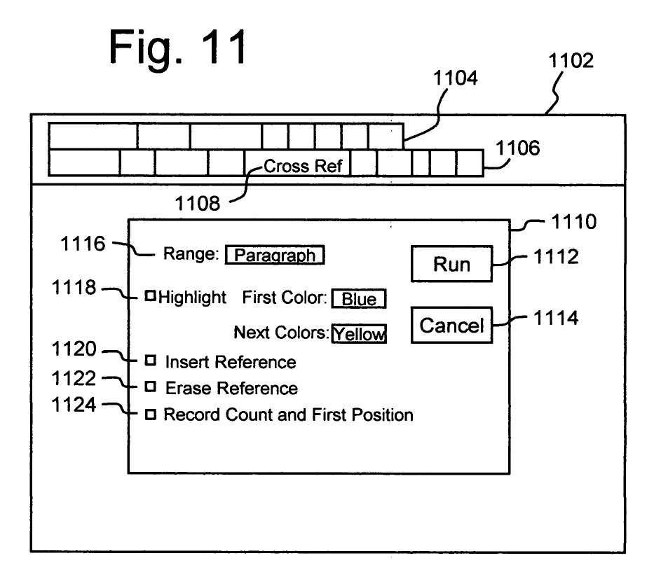

FIG. 11 illustrates a user screen showing the presentation of the word processing environment and an option selection window 1110 to display cross reference options to be selected by the user. Referring to FIG. 11, the user screen comprises an optional first menu bar 1104, an optional second menu bar 1106, and a text editing window 1102. Many menu bars are available to display optional commands available to the user. Each menu bar comprises multiple command buttons to activate the respective feature. In accordance with the present invention, a cross reference command button 1108 to initiate the cross reference function may be placed on one of the command bars. The command buttons may be labeled with text or icons to indicate the associated feature. In one embodiment, the cross reference utility 504 is a function available from within the word processing environment. Being available within the word processing enviornment streamlines and simplifies the operation compared with having to exit the word processor and run an external utility on the file and then return to the word processor.

Also shown in FIG. 11 is an option selection window 1110 for the cross reference utility 504. The option selection window 1110 is typically shown upon selecting the cross reference command button 1108. Using the option selection window 1110, the user may select the range of operation using the range selection combobox 1116. The range may be the current selection, paragraph, section, or disclosure. The user may select whether to highlight 302 the matching text or not using a highlightx check box 1118, and if highlightx is checked, the user may select the highlight 302 color of the first occurrence of a match for a given term 104 and the highlight 302 color for the subsequent matches for that term 104.

Using the insert reference check box 1120, the user may select whether to insert the reference from the cross reference table 202 or not to insert the reference. Selecting to insert the reference could be used to just highlight 302 the text. Using the erase reference check box 1122, the user may select to delete any reference numbers 106 found and not add a replacement. Using the record count and first position check box 1124, the user may select to record the count of the number of occurrences for each reference and the location of the first occurrence. Other user options may be added to the option selection window 1110 to select other features as desired for a specific implementation in accordance with the present invention. When the user has selected the desired options, the RUN button 1112 may be selected to run the cross reference utility 504, or the CANCEL button 1114 may be selected to return to the word processor without running the cross reference utility 504.

Computer Host

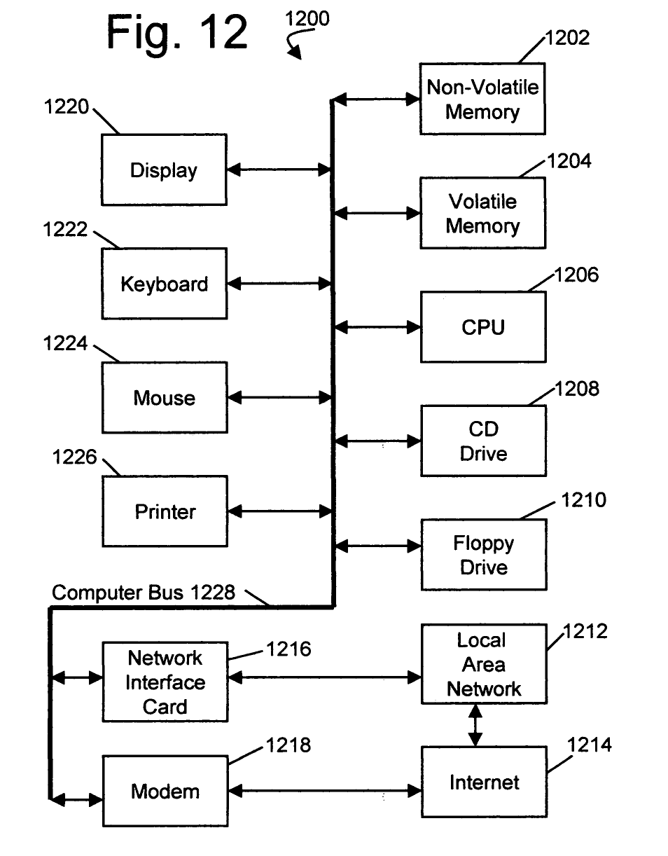

FIG. 12 is a block diagram illustrating a typical computer host 1200 that may run the word processor application including the cross reference utility 504. Referring to FIG. 12 the cross reference utility 504 may be installed and stored in a non-volatile memory 1204 unit for ready access when needed.

The computer program instructions for running the Cross Reference utility 504 may be supplied on a removable storage device such as a compact disk (CD), DVD, floppy, memory stick, or other removable storage device or medium to be read by a CD drive 1208, floppy drive 1210 or other associated device. Alternatively, the program instructions may be stored on a server connected to the computer by a network such as a local area network 1212 or the Internet 1214 and downloaded or run from network resources. The memory and peripheral devices are interconnected to the computer CPU 1206 by a computer bus 1228.

In operation, the computer is turned on and the operating system is loaded. The cross reference utility 504 source is initially accessed, or installed, for example, by placing a CD in the CD drive 1208 or by downloading and storing a software file from a local area network 1212 or internet 1214 using a network interface 1216 or a modem 1218. The CD or software file may contain an installation utility to help the user install the software. The software is then installed by storing appropriate files on the non-volatile memory 1204 and updating system information files to indicate the presence of the new software. In the case of a cross reference utility 504 designed to work with Microsoft® Word, the cross reference utility 504 may be contained in a template file which is stored in a templates directory associated with the word processor program. Once installed, the user opens the word processor program, selects File-New and is presented with an option screen including an icon for the new template. Double clicking on the new template with the mouse 1224 will open the word processor program with the new template file attached. New command buttons will be displayed for the new functions now available. The word processor is then ready to enter text and begin creating a document.

When sufficient text is entered using the xkeyboard 1222 to begin utilizing the cross reference utility 504, a cross reference table 202 is created and the cross reference utility 504 is initiated using the mouse 1224 to select the cross reference command button 1108. Results are then displayed on the display 1220 where the modified text including added reference numbers 106 and highlighting may be reviewed. Based on the results, the document may be modified to correct or improve the text and the cross reference utility 504 may be rerun to verify a correct result. As the process continues, the document may be printed using the printer 1226. When complete, the document may be printed using the printer 1226 and may be sent over the local area network 1212 or intemet 1214 to a client or customer or other associate.

Alternative Embodiments

In a further embodiment of the invention, the cross reference utility 504 is constructed to be initiated independently and run from an independent utility control window. In one variation of this embodiment, the word processing system 502 object model functions may be accessed through the automation interface to gain access to the text and text attributes at a high programming level. In another variation of this embodiment, the cross reference utility 504 may access the text directly, interpreting formatting and other text attributes as needed. The direct interpretation process may be simplified by using standardized file types such as TXT or RTF files.

In another embodiment of the invention, the cross reference table 202 may be external to the word processing document file. For example the cross reference file may be a tab delimited text file, a comma delimited text file, or a binary file, or may be a spreadsheet file such as a Microsoft® Excel file. The external files may take numerous formats and structures as elected by the programmer. For example, a tab delimited text file may comprise a sequence of lines each comprising the term 104 followed by a tab character followed by the reference followed by a line feed character. To utilize the text file from within the cross reference utility 504, the user option window would include a box to specify the file name, or allow browsing to find the file. The program code could be modified to read the text file into a memory array and then process the document in accordance with each term 104 in the memory array.

A spreadsheet program may be used to implement a cross reference table 202 for example, by placing the terms 104 in column 1 and the reference numbers 106 in column 2. The appropriate automation interface would then be used from within the word processor system to access the spreadsheet data by row and column.

Although much of this disclosure which discusses word processing systems 502 has accompanying examples and illustrations utilizing Microsoft® Word, the invention is not limited to Microsoft® Word, but may be implemented in association with other word processing systems 502 that afford similar macro capability or other programming interfaces that allow sufficient access to the document to practice the invention. One such alternative word processing system 502 is Word Perfect.

In a further embodiment, text characteristics, such as highlighting color, text color, bold, or font may be assigned in accordance with a matching status. Matching status may include:
New Match—matches with no prior associated reference number
Existing match—matches with an existing reference number
Modified match—existing matches wherein the reference number is modified

New matches are matches with no prior associated reference number, e.g., when the cross reference tool finds a match and does not find an existing reference number in the text following the match, the match is designated a new match. If the cross reference tool finds an existing reference number following the matching text the match is designated an existing match. The cross reference tool may then test the existing reference number to see if the existing reference number is equal to the table value indicating the correct reference. number. If the existing reference number is not equal to the correct reference number, the existing reference number may be changed and designated as a modified match. For example, three higlighting colors may be used to designate the matching status. Yellow may be used to indicate unchanged existing matches, blue may be used to indicate modified existing matches, and red may be used to indicate new matches. Further, it may be advantageous to make the status persistent, i.e., new and modified match status may remain through several runnings of the cross reference tool so that a given paragraph or section may be worked on through several iterations and still show clearly the new matches. New matches may be converted to existing matches upon user selection of a command or check box to update reference status, or may be updated automatically in accordance with a revision number, or may be updated according to time or date.

In another embodiment, a marker is provided to indicate to the cross reference utility to freeze a portion of text against changes. The marker may be placed as hidden text in the paragraph or may be stored in a table or elsewhere in the document. The marker may be used to prevent new matches or alternatively or in combination, may be used to prevent updating the references. Thus, a portion of text may be included in the document that contains special text or special usage that the cross reference utility may interfere with. The use of the marker could prevent operation on that paragraph or section to preserve the special text.

In one embodiment a character is imbedded in the text to indicate to the cross reference utilty not to match or not to update matches in the portion marked. For example, a tilde (˜) character may be embedded using hidden text to mark the start of a section to be skipped. Another tilde may be used to stop the skipping and resume matching. Alternatively a tilde followed by another character such as “1” may indicate the start of a section where new matching is prevented. A tilde followed by a “2” may indicate the start of a section where updating is prevented. A tilde followed by a “3” may indicate the start of a section where both new matching and updating is prevented. A tilde followed by a “0” may indicate to resume full matching and updating.

Alternatively, a tilde followed by another character at the end of a paragraph may indicate to treat the paragraph according to the action indicated by the following character.

A tilde is suggested as a marker character because it is infrequently used in English text. Other characters or character combinations may be used. Note also that the tilde used as a marker is a hidden tilde. A non-hidden tilde may be treated as ordinary text.

In another embodiment, a table is used to store information on special treatment of the text. For example, a two column table may be created in the document. One column may use a range object to indicate the starting and ending points of special treatment. The second column may be a character indicating the special treatment, such as no new matching or no updating of references.

In another embodiment, the marker character may be embedded in or near each instance of matching text to indicate not to update references.

Conclusion

While various exemplary embodiments of the present invention have been described above, it should be understood that the exemplary embodiments have been presented by way of example only, and not limitation. It will be understood by those skilled in the art that various changes in form and details may be made therein without departing from the spirit and scope of the invention as described in the appended claims. Thus, the breadth and scope of the present invention should not be limited by any of the above described exemplary embodiments, but should be defined only in accordance with the following claims and their equivalents.

1. A method for computer assisted development of a document, said method comprising the steps of:
providing a digital representation of the document; said digital representation of the document comprising text having at least one property; said property having a value;
providing a digital representation of a cross reference table, said cross reference table including at least one term and an associated reference number;
searching said digital representation of the document for matching text wherein said matching text matches said at least one term in said cross reference table; and
inserting text for said associated reference number in said digital representation of the document.

2. The method of claim 1 including the step of changing the value of said at least one property of said matching text.

3. The method of claim 2 including the step of setting the value of at least one property of said text for said associated reference number.

4. The method of claim 1 wherein the insertion of said reference number observes at least one punctuation rule.

5. A method for assisting in the development of a document, said method comprising the steps of:
providing a digital representation of the document; said digital representation of the document comprising text having at least one property; said property having a value;
providing a digital representation of a cross reference table, said cross reference table including at least one term and an associated reference number;
searching said digital representation of the document for matching text wherein said matching text matches said at least one term in said cross reference table; and
changing the text property of said matching text.

6. The method of claim 1 wherein the text property is a highlight color.

7. The method of claim 1 wherein the text property is the font.

8. The method of claim 1 wherein the text property is the text color.

9. The method of claim 1 wherein the text property is further defined by a matching status.

10. The method of claim 9 wherein the matching status is one of: new match, existing match, or modified match.

11. The method of claim 1 wherein a portion of said text is prevented from changing the value of the text property of said matching text.

12. The method of claim 1 wherein the document includes more than one match and wherein the text property for the first occurrence of said match is set to a different value than the value of the text property for subsequent occurrences of said match.

13. The method of claim 1 further including the step of counting the number of occurrences of matching text in a portion of said digital representation of the document.

14. The method of claim 13 further including the step of inserting the number of occurrences of matching text in the digital representation of the document.

15. The method of claim 14 wherein said cross reference table is included in said digital representation of the document and said number of matches is inserted into said cross reference table.

16. The method of claim 1 wherein the cross reference table is included in said digital representation of the document.

17. The method of claim 1 wherein the matching automatically includes matching a plural form of said at least one term.

18. The method of claim 1 wherein the matching is performed using a macro command functionality of a word processor.

19. The method of claim 1 wherein the marching uses functions available in an object model of a word processor

20. The method of claim 19 wherein the matching fumctions are programmed using a visual basic programming environment associated with said word processor.

21. The method of claim 20 wherein the word processor is Microsoft Word®.
